(19) United States
(12) Patent Application Publication
(10) Pub. No.: US 2003/0170107 A1
(43) Pub. Date: Sep. 11, 2003

(54) Self-propelled transport and handling device

(76) Inventor: Roger Soler, Hericourt (FR)

Correspondence Address: HARRISON & EGBERT, 412 MAIN STREET, 7TH FLOOR, HOUSTON, TX, 77002, US

(21) Appl. No.: 10/257,519

(22) PCT Filed: Apr. 12, 2001
(86) PCT No.: PCT/FR01/01134

(51) Int. Cl. B65G 1/00

(52) U.S. Cl. 414/563

(57) ABSTRACT

The invention concerns a self-propelled transport and handling device (1) for picking up and towing a load (2), such as a skip (3), comprising a rigid structure (4) provided with running (9) or sliding means at least in its rear part (8), opposite catching means (6) provided on its front part (5) and capable of co-operating with towing means (7) associated with said device (1), which comprises at least a wheel (10) both steering and driving. Said device is characterized in that it comprises a hook (12) capable of co-operating with said catching means (6) with matching shape and lateral grip means (13) designed to be urged to be fastened, from the lateral sides of the load (2) to prevent the self-propelled device (1) from rotating relative to said load (2) about a vertical pivoting axis passing substantially through the hook (12).

### BACKGROUND OF THE INVENTION

(1) Field of the Invention

The invention relates to a self-propelled transport and handling device for picking up and towing a load, such as a loading platform, a skip or the like, comprising a rigid structure provided with rolling or sliding means at least in its rear portion, opposite catching means provided on its front portion and capable of co-operating with towing means associated with said device, which comprises at least a steering and driving wheel.

This invention will find its application in the field of the devices capable of moving, on industrial working sites or the like, loads including a rigid structure provided with rolling means at least at its rear portion. Thus, such loads can adopt the form of transportation means, for example that of a loading platform, of a skip or the like, whereby it should be known that this invention is in no way limited to such an application.

(2) Description of the Prior Art

These skips that are used in both the industrial sectors and in the environmental sectors, for example in the waste-processing plants, and that are most often aimed at containing various kinds of waste have been known for many years.

The peculiarity of these skips resides in that they include, at the rear of their rigid structure, rolling means in the form of rollers, while at the front portion are provided for catching means which a handling hook provided on a most classical self-propelling transport device is capable of co-operating with. More specifically, through this hook and said catching means said transport vehicle is capable of lifting, at the front portion, said skip, in order to progressively draw it onto its loading platform provided with rollers facilitating the advancing of the skip. It should be noted that the presence, at the rear portion of the skip, of castors allows it to easily move on the ground when it is lifted by the transport vehicle during the loading operation.

Such a transport vehicle equipped in such a way obviously represents a not inconsiderable capital investment, in particular when it is aimed at transporting said skips only on the working site itself.

In addition, important handling constraints are experienced, for example, when replacing a full skip by an empty skip that must necessarily take the place of the preceding one. Indeed, the full skip must first be moved and, to this end, the empty skip must be unloaded from the transport vehicle. Then, after having removed the full skip, the empty skip must be picked up again, in order to bring it into its final position. During all these handling operations, the transport vehicle and its driver are obviously immobilized.

Since such skips are provided at least at their rear portion with rolling means, this in order to allow their loading onto a transport vehicle as described above, it has been devised to motorize such skips.

Thus, in FR-A-1,097,434 is disclosed a pushing and towing driving machine for moving loading trucks, namely intended for tile works, building sites, loading ramps, etc . . . . This machine includes a vertical steering column that can be rotated by means of a handlebar and extending above motor-driven rolling means. Finally, once the device is associated with the loading truck, the aggregate forms a multiple-axle loading vehicle that is capable of being guided.

It is clearly stated that the steering column serves, internally, for mounting the driving shaft and, externally, for mounting a lifting device including a jack cover provided with hooks located above each other and aimed at inserting into complementary catching means the loading truck includes.

U.S. Pat. No. 4,321,977 discloses, in turn, a handling vehicle substantially similar to a traditional tractor vehicle and including, under a driver's platform, rolling means with steering devices, as well as pivoting rear rolling means that are, furthermore, mounted on lifting means. This vehicle includes, at the rear portion, catching means aimed at co-operating with the load to be carried. In order to be capable of picking up a skip, these catching means are, in particular, designed capable of seizing the latter on both sides, both at its upper portion and at its lower portion.

This design results in that these catching means of the handling vehicle are capable of co-operating with the complementary means of the skip only when they are perfectly positioned with respect to each other and this at the level of the four corners of this skip.

There are also disclosed other embodiments of these catching means, which do however not cope with the constraints experienced in the field.

### SUMMARY OF THE INVENTION

Thus, this invention relates to a self-propelled transport and handling device for picking up and towing a load, such as a loading platform, a skip or the like, including a rigid structure provided with rolling or sliding means at least in its rear portion, opposite catching means provided for on its front portion and capable of co-operating with towing means associated with said device, which comprises at least a steering and driving wheel. This device is characterized in that the towing means consist of means designed capable of making integral, without freedom of movement relative to each other, said device with the load to be towed and include, on the one hand, a hook capable of co-operating with said catching means with matching shape and, on the other hand, lateral gripping means designed capable of being fastened, from the lateral sides, at the level of these catching means of the load, in order to prevent the self-propelled device from rotating relative to said load about a vertical pivoting axis passing substantially through the hook.

One should note, in particular that the action of lifting a skip by means of a hook according to the invention results into an action of tilting of the skip, with respect to the transport device, about a horizontal axis passing through said hook, so that this skip applies, at the lower portion, against said transport device, where it is maintained through lateral gripping means.

According to the advantageous embodiment of the invention, the self-propelled device includes, besides the steering and driving wheels, auxiliary rolling means that allow ensuring its stability and authorizing its movements in the absence of a towed load.

As regards the control means associated with this device and allowing controlling its operation, these can be in the form of a driver's platform provided for at the level of its structure, whereby it should be known that this control can also be carried out remotely, whether or not through a cable connection.

The preceding description already shows that the self-propelled device according to the invention proves to be of a particularly simple design and that its cost price can be very low, compared to a transport vehicle of the type used until now for moving these waste skips.

Under such circumstances, it is, on the working sites, a much more practical tool than such a known road transport vehicle, which can be reserved for transporting these skips outside these sites.

In this respect, it should be noted that, in contrast to these transport vehicles, a self-propelled device according to the invention that is used only on the working site requires no special qualification for driving it.

The invention will be better understood when reading the following description, with reference to the attached drawings showing one embodiment.

### BRIEF DESCRIPTION OF THE DRAWINGS

FIG. 1 is a schematic view of the self-propelled device made integral with a load in the form of a skip provided, at its rear portion, with rolling means.

FIG. 2 is a schematic perspective view of the self-propelled device alone.

FIG. 3 is an elevational view of the self-propelled device according to the invention the auxiliary rolling means of which have been lowered, thus allowing it to freely move in the absence of a towed load.

FIG. 4 is a schematic plan view of the self-propelled device according to the invention.

FIG. 5 is a schematic rear view of the self-propelled device, showing in particular the towing means designed capable of co-operating with a load to be handled.

FIGS. 6, 7 and 8 schematically show the control means for steering, substantially over 180°, a steering and driving wheel of said self-propelled device.

### DETAILED DESCRIPTION OF THE PREFERRED EMBODIMENTS

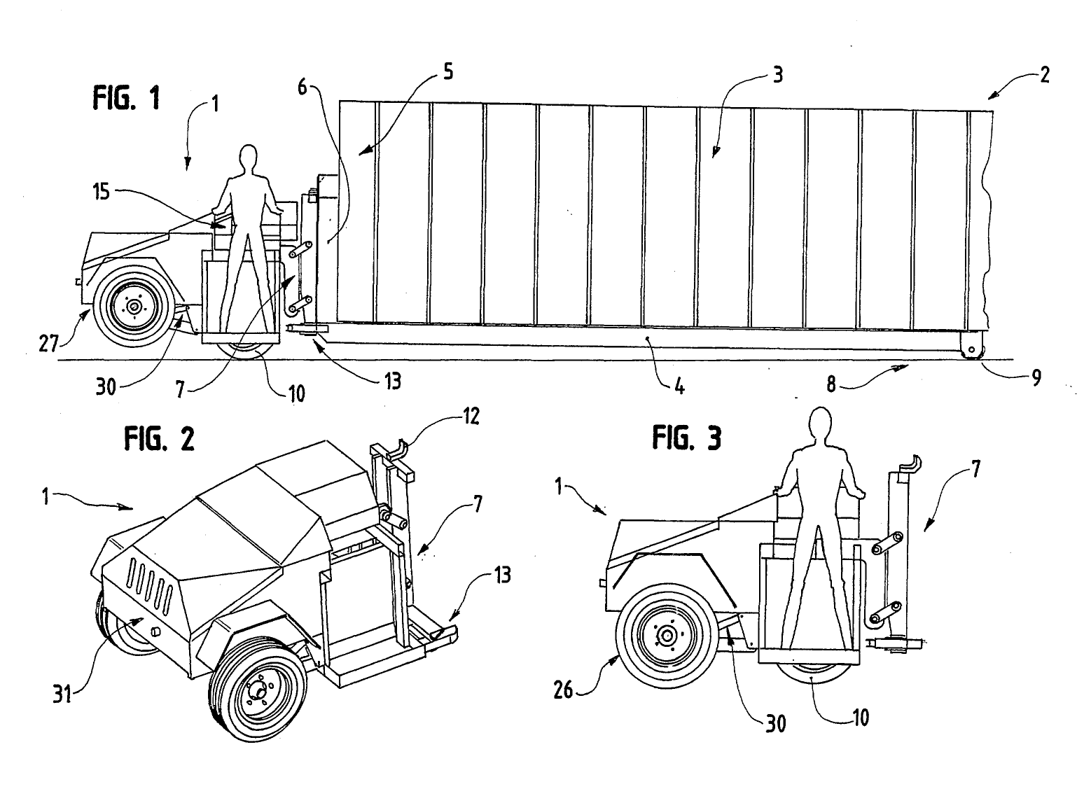

As shown in the figures of the attached drawings, this invention relates to a self-propelled transport and handling device 1 for picking up and towing a load 2, for example in the form of a loading platform or, as can be seen in FIG. 1, of a skip 3, whereby this summing up is in no way restrictive.

As a matter of fact, this load to be transported necessarily includes a rigid structure 4 provided, in its front portion 5, with catching means 6 capable of co-operating with towing means 7 of the self-propelled device 1, while this rigid structure 4 corresponding to the load 2 includes, in its rear portion 8, rolling means 9, at least sliding means.

By way of an example, the waste skips often meet the above description.

Turning back to the self-propelled device 1, this includes at least one steering and driving wheel 10, while the towing means 7 consist of means designed capable of making integral, without freedom of movement relative to each other, the self-propelled device 1 with the load 2 to be towed.

By thus making the self-propelled device 1 integral, through said towing means 7, with a skip 3, as described above, through the catching means the latter is provided with, this skip 3 can easily be moved and handled, since it rests on the ground, on the one hand, through its own rolling means 9 in its rear portion 8 and, on the other hand, through the steering and driving wheel 10 of said self-propelled device 1.

It should be noted that in the event the load 2 rests, before its picking up by the self-propelled device 1, directly on the ground, in its front portion 5, or through rolling means that do not pivot, i.e. which cannot be oriented, said self-propelled device 1 advantageously includes means 11 for lifting said load at this front portion 5.

Such lifting means 11 are preferably directly associated with the towing means 7 that, once they are brought into co-operation with the catching means 6 of said load 2, are capable of lifting the latter.

In substance, said towing means 7 are designed so as to be adapted to the catching means 6, in order to achieve the result looked for, i.e. making the self-propelled device 1 integral with the load 2, without freedom of movement relative to each other.

Thus, such towing means 7 include, on the one hand, a hook 12 aimed at co-operating with catching means 10 with a complementary shape and, on the other hand, lateral gripping means 13, which are shown more particularly in FIG. 4 and which are designed capable of hooking-in, from the lateral sides, at the level of these catching means 6 of the load 2. They are namely aimed at impeding the self-propelled device 1 from rotating with respect to this load 2 about a vertical pivoting axis substantially passing through the hook 12.

Of course, the operation of the lifting means 11, as well as that of the gripping means 13, can be ensured through hydraulic control means, taking into consideration that this invention is in no way limited to such a solution.

Likewise, as driving means this self-propelled device 1 is provided with, a thermal or electric engine can be used for operating, for example, a hydraulic central unit capable of feeding, in turn, the hydraulic jack or jacks corresponding to the lifting means 11 or to the gripping means 13, even a hydraulic or electric engine associated in a known way with the steering and driving wheel or wheels 10.

It would of course be understandable for the specialists in the art to ensure a direct mechanical connection between this or these steering and driving wheel or wheels 10 and said electric or thermal engine.

As regards the control means 14 associated with this self-propelled device 1, these can adopt the form of a driver's platform 15 provided for at the level of its structure, on which platform 15 an operator can eventually stand, as can be seen in FIG. 1.

This driver's platform 15 is arranged laterally, at the level of this structure of the self-propelled device 1, namely so as to allow a full side view on the load 2 during the displacements.

Such control means 14 can also adopt the form of a simple control panel capable of being connected, by means of a cable or through remote control means such as a radio or the like, to said self-propelled device 1.

Such a design of these control means 14 is particularly interesting within the framework of the application of such a self-propelled device 1 to the transport and handling of loads having smaller dimensions.

By way of an example, this invention can be applied to the transport and handling of a rolling jack for an aircraft. Such a jack rests, both at its front portion and its rear portion, on rolling means and though those located at the front portion of this jack are pivoting and, hence, steering, the handling of the latter proves difficult.

Finally, as appears from the preceding example, the self-propelled device 1 object of the invention is in no way limited to applications for the transport and handling of heavy loads, such as skips.

Though, as results from the description of this self-propelled device 1, the latter can receive several steering and driving wheels 10 and can, in particular, be provided with a steering axle, according to an advantageous embodiment of the invention it includes only one steering and driving wheel 10 pivotally mounted, as shown in FIGS. 6 to 8, about a vertical pivoting axis 16 passing substantially at the level of its median plane.

In this respect, a parenthesis has to be made. Indeed, when reference is made to one single wheel, though the latter can be in the form of one single rim with one single tire, it can also be provided with several rims, in particular two rims, arranged side by side, each receiving a tire.

Anyway, with this wheel are associated steering control means 17 that are preferably designed so as to subject said wheel 10 to a rotation of more or less 90° with respect to its reference position 18, on the axis 19 of the load 2, corresponding to FIG. 6.

Thus, said control means 17 are in the form of a set of two connecting rods 20 and 21 hinging relative to each other at the level of their one end, the other end of the connecting rod 20 being pivotally fixed to the retaining plate 22 on which the wheel 10 is mounted, while the connecting rod 21 is mounted in a hinging way, at its end opposite the previous connecting rod 20, at a fixed location 23 at the level of the self-propelled device 1. Beyond this fixed location 23 on the structure, this connecting rod 21 is furthermore extended by a lever 24 on which acts a control organ 25, here shown in the form of a jack.

Such a design, which allows causing the steering and driving wheel 10 to pivot over substantially 180°, has the advantage of facilitating the displacements of the load 2. In particular, it is possible to cause it to pivot according to a reduced radius of curvature.

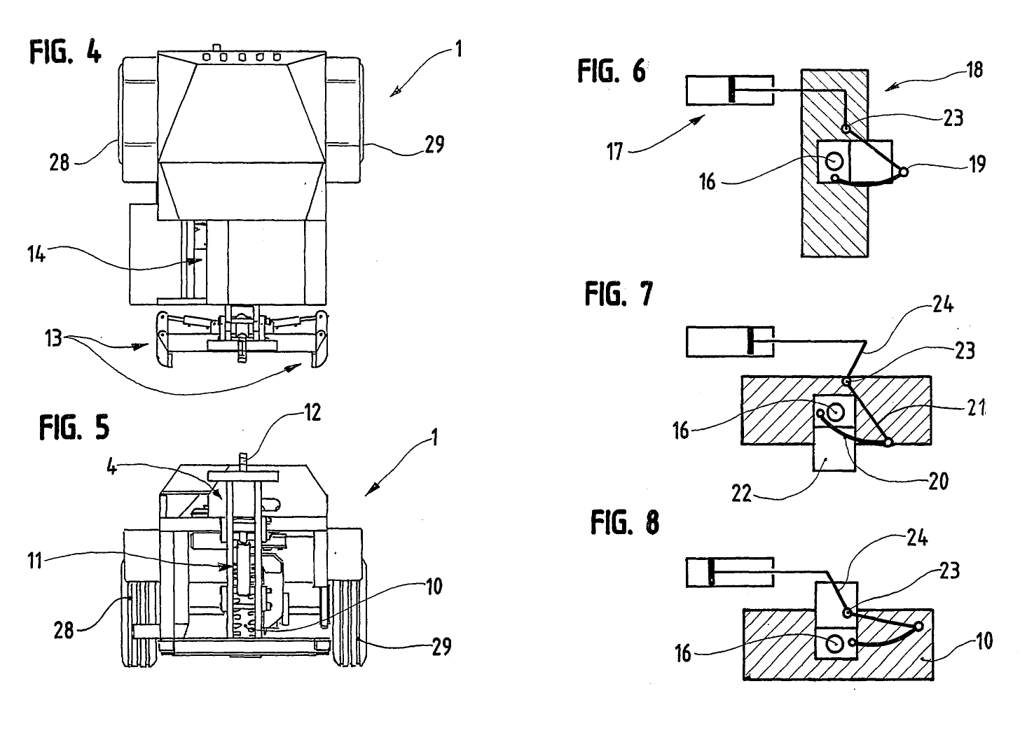

As can be seen in FIGS. 1 to 5, this self-propelled device 1 can also receive auxiliary rolling means 26 designed capable of providing it with the necessary stability to allow it to move after it has been dissociated from a load 2.

Such auxiliary rolling means 26 are preferably in the form of a fixed axle 27 receiving, on both sides, a wheel 28, 29 and located behind or, as shown in these figures, in front of the steering and driving wheel or wheels 10.

Such auxiliary rolling means 26 are advantageously designed retractile, i.e. so as to allow releasing their wheels 28, 29 from resting on the ground once the self-propelled device 1 has been made integral with the load 2 through the towing means 7.

Thus, this self-propelled device 1 receives lifting means 30, for example in the form of a jack, designed capable of raising the axle 27, as shown in FIG. 1, and of course, on the other hand, of lowering it, namely when the self-propelled device 1 has to move alone. Through such lifting means 30 and provided said rolling means are located in front of the steering and driving wheel 10, it is also possible to cause the self-propelled device 1 to tilt about this wheel 10, in particular to lower the towing means 7 and to thus bring them at the same level as the catching means 6 of the load 2 when the latter rests directly on the ground.

As results from the preceding description, such a self-propelled device 1 has a particularly simple design, so that its cost price is necessarily low. Thus, in an application for the transport and handling of skips, such as waste skips, such a self-propelled device 1 largely facilitates the control of these skips, taking into consideration that their displacement on the working site proves very easy. In this respect, this control can be ensured by an operator without any special authorization such as a driving license for a transport vehicle.

Finally, it should be noted that in the front portion 31 of this self-propelled device 1 can be mounted one or several accessories, which are particularly useful on such industrial working sites or the like.

For example, at the front portion of this self-propelled device 1 can be mounted a snow-clearing blade. Furthermore, its being eventually provided with a hydraulic pump for feeding the various hydraulic controls, even the hydraulic driving engine for the wheel 10, allows contemplating the connection, in this front portion 11 of the self-propelled device 1, of hydraulically operated accessories, such as a spade, a hoisting device or the like.

Finally, it should be reminded once again that, though the self-propelled device 1 has been depicted and described mainly within the framework of an application to the transport and handling of a load, such as a loading platform, skips and the like, it is also possible to imagine designing it at reduced scale for the transport and handling of smaller loads, similar to the example of the jack for an aircraft, which has been referred to above.

What is claimed:

1. Self-propelled transport and handling device (1) for picking up and towing a load (2), such as a loading platform, a skip (3) or the like, including a rigid structure (4) provided with rolling (9) or sliding means at least in its rear portion (8), opposite catching means (6) provided for on its front portion (5) and capable of co-operating with towing means (7) associated with said device (1), which comprises at least a steering and driving wheel (10), characterized in that the towing means (7) consist of means designed capable of making integral, without freedom of movement relative to each other, said device (1) with the load to be towed (2) and include, on the one hand, a hook (12) capable of co-operating with said catching means (6) with matching shape and, on the other hand, lateral gripping means (13) designed capable of being fastened, from the lateral sides, at the level of these catching means (6) of the load (2), in order to prevent the self-propelled device (1) from rotating relative to this load (2) about a vertical pivoting axis passing substantially through the hook (12).

2. Self-propelled device (1) according to claim 1, characterized in that it includes lifting means (11) designed capable of lifting said load (2) at this front portion (5), these lifting means (11) being associated with the towing means (7) that, once they are brought into co-operation with the catching means (6) of the load (2), are capable of lifting the latter.

3. Self-propelled device (1) according to any of the preceding claims, characterized in that it includes one single steering and driving wheel (10) pivotally mounted about a vertical pivoting axis (15) passing substantially at the level of its median plane, with this wheel (10) being associated steering control means (17) that are namely designed so as to subject it to a rotation of more or less 90° with respect to its reference position (18), on the axis (19) of the load (2).

4. Self-propelled device (1) according to any of the preceding claims, characterized in that it includes a thermal or electric engine for ensuring the operation of a hydraulic central unit for feeding hydraulic jacks corresponding to lifting means (11) and/or gripping means (13) associated with the towing means (7), as well as a hydraulic engine associated with the steering and driving wheel or wheels (10).

5. Self-propelled device (1) according to any of the preceding claims, characterized in that it includes control means (14) provided for at the level of its structure, in the form of a driver's platform (15) designed so as to receive an operator.

6. Self-propelled device (1) according to claim 5, characterized in that the driver's platform (15) is arranged laterally, at the level of this structure of the self-propelled device (1), so as to allow a side view on the load (2).

7. Self-propelled device (1) according to any of claims 1 to 4, characterized in that it includes control means (14) in the form of a control panel capable of being connected, by means of a cable or through remote control means such as a radio or the like, to said self-propelled device (1).

8. Self-propelled device (1) according to any of the preceding claims, characterized in that it includes auxiliary rolling means (26) designed capable of providing it with the necessary stability to allow it to move after it has been dissociated from a load (2), such auxiliary rolling means (26) being designed retractile, through lifting means (30), so as to allow releasing their wheels (28, 29) from resting on the ground once the self-propelled device (1) has been made integral with the load (2).

9. Self-propelled device (1) according to any of the preceding claims, characterized in that it is designed capable of receiving, at the front portion (31), one or several accessories, namely hydraulically operated accessories.
